(19) United States
(12) Patent Application Publication
(10) Pub. No.: US 2006/0266842 A1
(43) Pub. Date: Nov. 30, 2006

(54) COUNTER STRIP

(76) Inventor: Donald G. Boggs, Bellville, TX (US)

Correspondence Address: PATENT-TRADEMARK-COPYRIGHT. US, 2200 S. FORT APACHE ROAD #1213, LAS VEGAS, NV, 89117, US

(21) Appl. No.: 10/908,877

(22) Filed: May 31, 2005

(51) Int. Cl. G06K 19/00; G06K 19/06

(52) U.S. Cl. 235/487; 235/494

(57) ABSTRACT

A counter strip is provided that provides a quantity indicator attachable to a container including an upper layer that has a series of indicia, such that selected ones of the series of indicia may be modified or removed and the remaining ones provide an indication of remaining quantities.

### FIELD OF THE INVENTION

The present invention relates generally to counting devices, and more particularly to a counter strip to track usage and monitor remaining dosages of medicines.

### BACKGROUND OF THE INVENTION

Medications and other consumable or expendable supplies are acquired and used by people each day. Usually, the number of dosages is listed on a container. However, as a person consumes or uses a medication or supply, the problem that usually occurs is that there is not a handy way to keep track of the remaining number of dosages.

One tracking device is to have tablet medications on a strip of individualized compartments. Examples include birth control pills and some cold tablet medications.

Unlike the aforementioned tablets, most medications and supplies are produced and sold in bulk containers. In the case of liquids or inhalants, the problem of keeping track of consumed doses and remaining doses becomes even more acute.

A user in most instances is left with finding a method for keeping track of the number of remaining dosages, such as visually estimating the remaining quantities or using a calendar or computer.

There is therefore a need for a simple device for keeping track of doses used or consumed and remaining doses in a given container so that a consumer can easily determine when it is needed to purchase additional supplies or medication.

### SUMMARY OF THE INVENTION

The present invention provides a counter strip for tracking doses as a consumer consumes or uses a dosage or measured quantity that may be affixed to a container or other related device or material for medication or other consumable substance. The counter strip comprises a series of consecutive numbers, symbols, etchings, designs, impressions, markings, or combination thereof that are associable with doses or measured quantities in a container.

### BRIEF DESCRIPTION OF THE DRAWINGS

The accompanying drawings incorporated in and forming a part of the specification, illustrates several aspects of the present invention, and together with the description serves to explain the principles of the invention. In the drawing:

FIG. 1A is a side view of the counter strip of an embodiment of the present invention attachable onto a surface, such as an external container surface.

FIG. 1B is an overhead view of the counter strip of an embodiment of the present invention that shows a visible series of numbers associable with doses or portions.

FIG. 2A is a side view of the counter strip of a second embodiment of the present invention attachable onto a surface, such as an external container surface, and includes an exposable second layered surface for coding, such as color-coding.

FIG. 2B is an overhead view of the counter strip of the second embodiment of the present invention that shows a visible series of numbers associable with doses or portions.

FIG. 2C is an overhead view of the counter strip of the second embodiment of the present invention that shows a visible series of circular removable perforations surrounding numbers associable with doses or portions.

FIG. 3A is a side view of an inhaler with the counter strip of the present invention circularly attached to the external surface.

FIG. 3B is an overhead view of a medication label with the counter strip of the present invention incorporated.

### DETAILED DESCRIPTION OF THE INVENTION

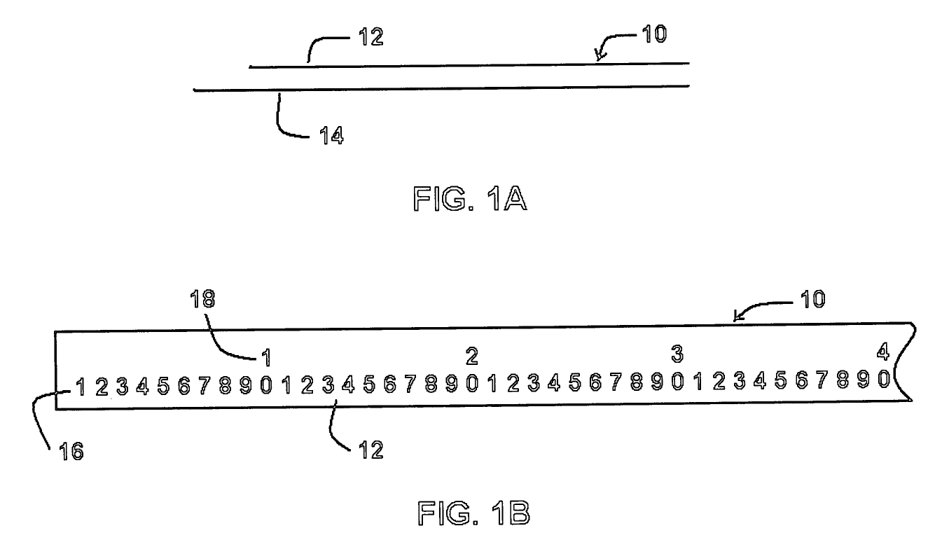

Referring to FIG. 1A, counter strip 10 of the present invention is shown in a first embodiment. In the first embodiment, counter strip 10 comprises two layers: upper layer 12 and lower layer 14. Upper layer 12 comprises a strip of paper or other flexible material with a viewable surface including a series of numbers for associating with doses of medication or measured portions of a consumable or usable substance and an adhesive under surface for attaching counter strip 10 to a medication or other container or material associated with the medication or other substance. Lower layer 14 comprises a removable paper for protecting the adhesive surface until a user is ready to attach counter strip 10 to a product.

Referring to FIG. 1B, upper layer 12 of counter strip 10 is shown comprising a first series of numbers 16 and a second series of numbers 18. First series of numbers 16 ranges from the number one through zero. Second series of numbers 18 are incremented consecutively from one and are placed above the zeros of the first series of numbers 16. When read together second series of numbers 18 indicates decades (or tens).

In the first embodiment, a user can maintain an accurate count of each dose consumed by marking through, removing, scoring or punching out all, or a portion of the corresponding number associated with the dose. Counts can be recorded incrementally starting with the first digit or decremented by starting with the highest number and recording in reverse order. Simply by looking at counter strip 10, a person, either the user or a person monitoring the medication or substance, can visually see the total doses consumed, and the total doses remaining.

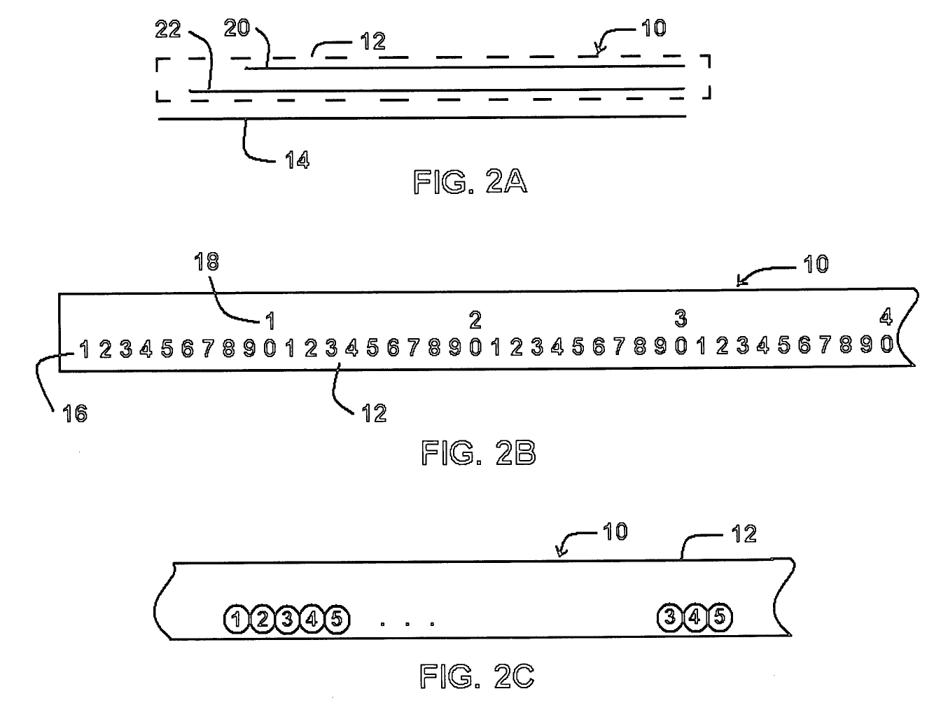

Referring to FIGS. 2A, 2B, and 2C, a second embodiment of the invention is shown wherein upper layer 12 comprises two layers 20, 22, such as two layer paper, flexible plastic, a two layer composite of paper and a removable or scrape-able coating. Layer 20 includes the series 16, 18 of the numbers visible as in the first embodiment. Additionally, around each of the numbers, layer 20 is perforated (see FIG. 2C) such that a user can remove each number corresponding to a dose and expose layer 22. It may be appreciated that if a scrape-able upper layer 20 is applied to layer 22, then the perforations may be dispensed with. Examples of scrape-able dual layers include the scrape-able lottery tickets or prize tickets that have exposable under layers (such as layer 22) and scrape-able upper layer (such as layer 20) which can be scraped with a coin or other firm object.

Layer 22 comprises an exposable surface that has a different color from layer 20 so that a user may easily see the usage and remaining dosage similarly to an incremental marker. In one embodiment, layer 22 simply has a mono-color, such as blue, while layer 20 has a mono-color, such as white. In another embodiment, layer 22 has a multi-color exposable surface, such as ranging from blue to amber to red, and giving an indication to a user when the level of doses available is high, medium, and low. The coloring red indicating that a user should obtain a refill, the color amber indicating that the user should monitor the doses, and the color blue indicating that there is an ample supply of medication or the substance available. The additional colored sub-surface material enhances the visual determination of doses consumed, as well as allows for quickly identifying the next number to be marked.

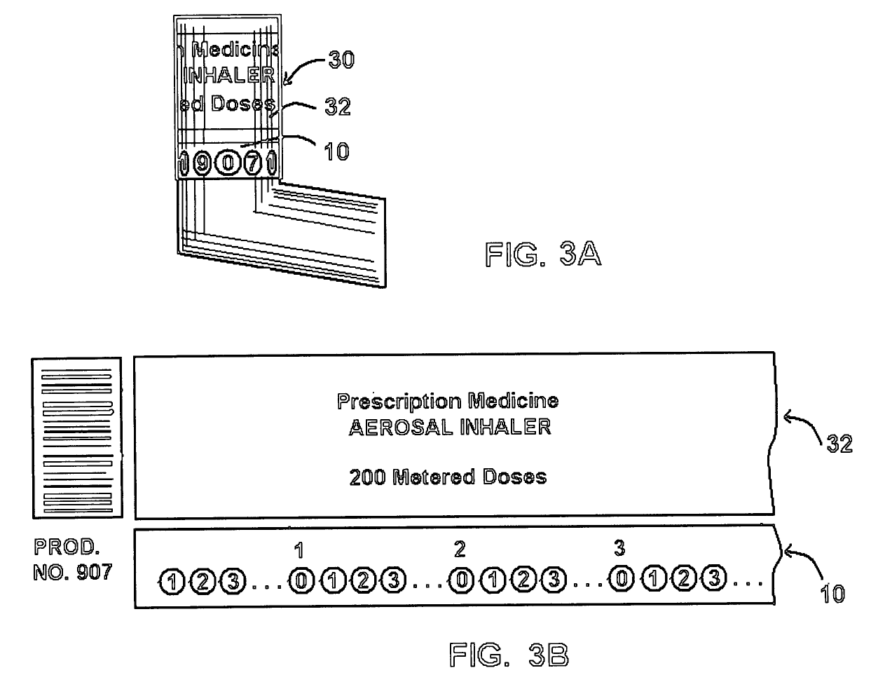

Referring to FIG. 3A, counter strip 10 of either of the embodiments described or contemplated above is attached by its adhesive surface to inhaler bottle 30. It may be appreciated that a user can view and mark off a number from counter strip 10 as a user utilizes a dosage from the container. By simply viewing counter strip 10, a user can determine when the container medication is nearly depleted and obtain a refill.

Referring to FIG. 3B, counter strip 10 of the present invention is shown in a third embodiment wherein counter strip 10 is incorporated within the manufacturer's product label 32 itself. It may be appreciated that counter strip 10 may be applied as part of an adhesive label as shown in FIG. 3B or as part of a container, such as a cardboard or plastic container where the information and indicia of counter strip 10 may be applied as part of a printing or etching process. This embodiment may incorporate the single layer of the first embodiment or the double layer of the second embodiment depending on the sophistication of the manufacturing process.

The foregoing description includes the preferred embodiment of the present invention. The embodiments described are presented for purposes of illustration and description. It is not intended to be exhaustive or to limit the invention to the precise form disclosed. Obvious modifications or variations are possible in light of the above teachings. The embodiments described are chosen to provide the best illustration of the principles of the present invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably titled.

What is claimed is:

1. A counter strip for providing an indicator of quantities of a substance within a container, the counter strip including an inscribed upper layer, the inscribed upper layer including a series of markings corresponding to selected quantities of the substance within the container.

2. The counter strip as in claim 1, selected ones of the series of markings modifiable by a user corresponding to usage of the substance, unmodified ones of the series of markings providing an indication of remaining quantities of the substance.

3. The counter strip as in claim 1, the counter strip including an adhesive lower layer for adhering the counter strip to the container.

4. The counter strip as in claim 3, the counter strip including a removable protecting layer attached to the adhesive lower layer and that protects the adhesive layer until removal by a user and application of the adhesive layer to the container.

5. The counter strip as in claim 2, the counter strip including an exposable second layer beneath the upper layer, the second layer being exposable when said selected ones of the series of markings are modified.

6. The counter strip as in claim 5, the exposable second layer being colored differently from the inscribed upper layer and aiding visual identification of quantity levels.

7. A medication container including a counter strip, the counter strip for providing an indicator of quantities of a substance within a container, the counter strip including an inscribed upper layer, the inscribed upper layer including a series of markings corresponding to selected quantities of the substance within the container; selected ones of the series of markings modifiable by a user corresponding to usage of the substance, unmodified ones of the series of markings providing an indication of remaining quantities of the substance.

8. A label for a medication container including a counter strip, the counter strip for providing an indicator of quantities of a substance within a container, the counter strip including an inscribed upper layer, the inscribed upper layer including a series of markings corresponding to selected quantities of the substance within the container; selected ones of the series of markings modifiable by a user corresponding to usage of the substance, unmodified ones of the series of markings providing an indication of remaining quantities of the substance.
